(19) United States
(12) Patent Application Publication
(10) Pub. No.: US 2024/0234771 A9
(43) Pub. Date: Jul. 11, 2024

(54) FUEL CELL SYSTEM

(71) Applicant: Versa Power Systems, Ltd, Danbury, CT (US)

(72) Inventor: Michael PASTULA, Danbury, CT (US)

(21) Appl. No.: 18/490,569

(22) Filed: Oct. 19, 2023

Related U.S. Application Data
(60) Provisional application No. 63/418,283, filed on Oct. 21, 2022.

(51) Int. Cl. H01M 8/0668; H01M 8/04089

(52) U.S. Cl. CPC H01M 8/0668; H01M 8/04097; H01M 2008/1293

(57) ABSTRACT

A fuel cell system includes a fuel source configured to provide a fuel input stream, a first carbon dioxide removal system configured to receive the fuel input stream and remove carbon dioxide from the fuel input stream, a fuel cell stack including an anode section having an anode inlet configured to receive an anode input stream, and an anode outlet configured to output an anode exhaust stream, and a cathode section having a cathode inlet configured to receive a cathode input stream, and a cathode outlet configured to output a cathode exhaust stream, an anode exhaust gas recycle system including a second carbon dioxide removal system configured to receive and remove carbon dioxide from the anode exhaust stream, and a combining junction configured to receive the fuel input stream, and the anode exhaust stream, and to output a mixed stream to the anode inlet as the anode input stream.

### CROSS-REFERENCE TO RELATED APPLICATION

This application claims the benefit of and priority to U.S. Provisional Application No. 63/418,283, filed Oct. 21, 2022, which is incorporated herein by reference in its entirety.

### BACKGROUND

The present disclosure relates generally to the field of electrochemical cells, such as fuel cells and electrolyzer cells, and more particularly to fuel cell systems with stack fuel exhaust recycle systems.

Generally, a fuel cell includes an anode section, a cathode section, and an electrolyte layer that together drive chemical reactions to produce electricity. Multiple fuel cells may be arranged in a stack to produce the desired amount of electricity. Fuel, such as hydrogen gas, hydrocarbon gas, or synthesis gas (e.g., syngas), is supplied to the anode section while oxidant (e.g., air, etc.) is supplied to the cathode section. The fuel and oxidant are used up by the electrochemical reactions as they flow over the anode section and cathode section, respectively.

To avoid excessive depletion of the reactant gases before reaching all areas of the cell, more fuel and oxidant are supplied than can react before the gases pass through the cells and out of the stack. For optimal design and to avoid waste, a portion of the unreacted gas (e.g., unreacted fuel) may be recycled back to the anode section inlet of the fuel cell and another portion of the unreacted gas may be directed to an afterburner, such as an anode gas oxidizer (e.g., AGO). However, it can be difficult to recycle the entirety or the majority of the unreacted gas.

### SUMMARY

Certain embodiments of the present disclosure may address the above-described problems with previous fuel cell systems.

In certain embodiments, a fuel cell system includes a fuel source configured to provide a fuel input stream, a first carbon dioxide removal system configured to receive the fuel input stream and remove carbon dioxide from the fuel input stream, and a fuel cell stack. The fuel cell stack includes an anode section having an anode inlet configured to receive an anode input stream, and an anode outlet configured to output an anode exhaust stream, and a cathode section having a cathode inlet configured to receive a cathode input stream, and a cathode outlet configured to output a cathode exhaust stream. The fuel cell system further includes an anode exhaust gas recycle system and a combining junction. The anode exhaust gas recycle system includes a second carbon dioxide removal system configured to receive the anode exhaust stream and remove carbon dioxide from the anode exhaust stream. The combining junction is configured to receive (i) the fuel input stream from the first carbon dioxide removal system, and (ii) the anode exhaust stream from the second carbon dioxide removal system, and to output a mixed stream to the anode inlet as the anode input stream.

In some aspects of the fuel cell system, the fuel cell stack is a solid oxide fuel cell stack.

In some aspects of the fuel cell system, the fuel input stream includes syngas.

In some aspects of the fuel cell system, the first carbon dioxide removal system is a carbon dioxide absorption system configured for use with an acid gas removal solvent.

In some aspects of the fuel cell system, the second carbon dioxide removal system is an amine-type carbon dioxide adsorption system.

In some aspects of the fuel cell system, the first carbon dioxide removal system is a carbon dioxide absorption system configured for use with an acid gas removal solvent, and the second carbon dioxide removal system is an amine-type carbon dioxide adsorption system.

In some aspects of the fuel cell system, the anode exhaust gas recycle system further includes a shift reactor configured to receive the anode exhaust stream and to convert carbon monoxide and water in the anode exhaust stream into carbon dioxide and hydrogen.

In some aspects, the fuel cell system further includes a heat recovery steam generator configured to receive the cathode exhaust stream and to heat a water stream using heat from the cathode exhaust stream.

In some aspects, the fuel cell system further includes an energy generation system having a steam turbine and a generator. The steam turbine is configured to receive the water stream from the heat recovery steam generator.

In some aspects of the fuel cell system, the heat recovery steam generator is configured to receive the cathode exhaust stream directly from the cathode outlet.

In some aspects, the fuel cell system does not include an anode gas oxidizer.

In some aspects, the fuel cell system further includes a separating junction configured to receive the anode exhaust stream from the second carbon dioxide removal system, and to output (i) a first portion of the anode exhaust stream to the combining junction, and (ii) a second portion of the anode exhaust stream to a waste fuel heat recovery system.

In certain embodiments, a method of generating electrical energy using a fuel cell system includes providing the fuel cell system. The fuel cell system includes a fuel source, a first carbon dioxide removal system, a fuel cell stack including an anode section having an anode inlet, and an anode outlet, and a cathode section having a cathode inlet, and a cathode outlet, an anode exhaust gas recycle system having a second carbon dioxide removal system, and a combining junction. The method further includes at the first carbon dioxide removal system, receiving a fuel input stream from the fuel source, and removing carbon dioxide from the fuel input stream, at the anode section of the fuel cell stack, receiving an anode input stream into the anode inlet, and outputting an anode exhaust stream from the anode outlet, at the cathode section of the fuel cell stack, receiving a cathode input stream into the cathode inlet, and outputting a cathode exhaust stream from the cathode outlet, at the second carbon dioxide removal system, receiving the anode exhaust stream and removing carbon dioxide from the anode exhaust stream, and at the combining junction, receiving (i) the fuel input stream from the first carbon dioxide removal system, and (ii) the anode exhaust stream from the second carbon dioxide removal system, and outputting a mixed stream to the anode inlet as the anode input stream.

In some aspects of the method, at the first carbon dioxide removal system, the step of removing the carbon dioxide from the fuel input stream is performed using an acid gas removal solvent.

In some aspects of the method, at the second carbon dioxide removal system, the step of removing the carbon dioxide from the anode exhaust stream is performed using an amine-type carbon dioxide adsorption system.

In some aspects of the method, at the first carbon dioxide removal system, the step of removing carbon dioxide from the fuel input stream is performed using an acid gas removal solvent, and, at the second carbon dioxide removal system, the step of removing the carbon dioxide from the anode exhaust stream is performed using an amine-type carbon dioxide adsorption system.

In some aspects of the method, the fuel cell system further includes a shift reactor, and the method further includes, at the shift reactor, converting carbon monoxide and water in the anode exhaust stream into carbon dioxide and hydrogen.

In some aspects of the method, the fuel cell system further includes a heat recovery steam generator, and the method further includes, at the heat recovery steam generator, heating a water stream using heat from the cathode exhaust stream.

In some aspects of the method, the fuel cell system does not include an anode gas oxidizer, and the method further includes, at the heat recovery steam generator, receiving the cathode exhaust stream directly from the cathode outlet.

In some aspects of the method, the fuel cell system further includes an energy generation system having a steam turbine and a generator, and the method further includes, at the heat recovery steam generator, directing the water stream to the steam turbine.

In some aspects of the method, the fuel cell system further includes a separating junction, and the method further includes, at the separating junction, receiving the anode exhaust stream and outputting (i) a first portion of the anode exhaust stream to the combining junction, and (ii) a second portion of the anode exhaust stream to a waste fuel heat recovery system.

### BRIEF DESCRIPTION OF THE DRAWINGS

The disclosure will become more fully understood from the following detailed description, taken in conjunction with the accompanying Figures, wherein like reference numerals refer to like elements unless otherwise indicated, in which:

FIG. 1 is a schematic diagram of a first fuel cell system according to an example embodiment; and

FIG. 2 is a schematic diagram of a second fuel cell system according to an example embodiment.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

In the following detailed description, reference is made to the accompanying Figures, which form a part hereof. In the Figures, similar symbols typically identify similar components, unless context dictates otherwise. The illustrative embodiments described in the detailed description, Figures, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and made part of this disclosure.

### I. Overview

Within high temperature fuel cell systems, the process produces unburned fuel that is often recycled. Typically, a portion of the unburned fuel is recycled back to an anode section of a fuel cell and another portion of the unburned fuel is directed to an afterburner, such as an anode gas oxidizer (e.g., AGO). It can be difficult to recycle the entirety or the majority of the unburned fuel.

Certain embodiments of the present disclosure provide improved fuel utilization of a fuel cell system, thereby increasing a fuel cell system efficiency. In particular, fuel utilization is improved using a carbon dioxide removal system within an anode exhaust gas recycle system, allowing the anode exhaust gas recycle system to maintain low pressure operation. Additionally, the minimal use or exclusion of an AGO within the fuel cell system reduces the amount of recyclable fuel that is oxidized, allowing the recyclable fuel to be recycled to the anode section of the fuel cell.

### II. Overview of Fuel Cell System

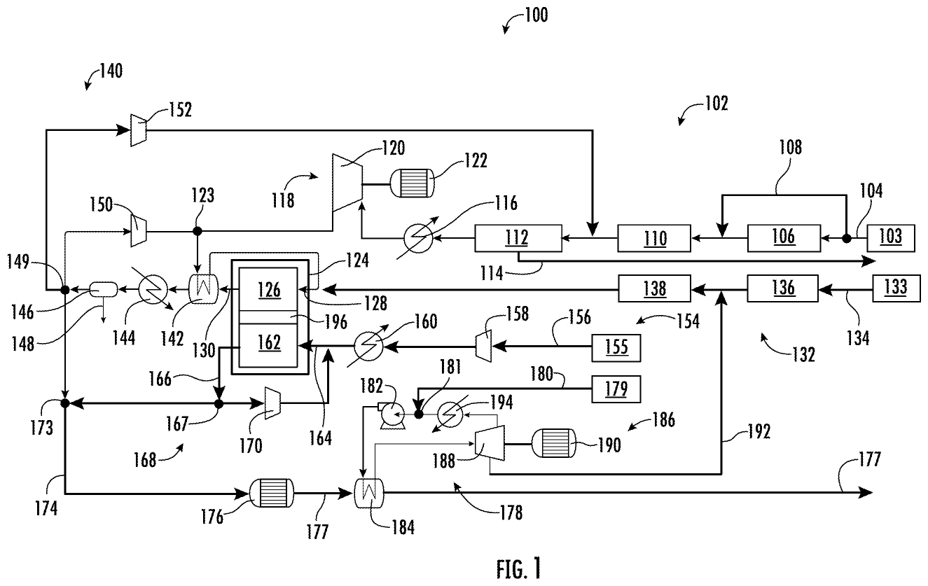

Referring to FIG. 1, a fuel cell system 100 according to an example embodiment is shown. The fuel cell system 100 includes a fuel input system 102 configured to input fuel into the fuel cell system 100. The fuel input system 102 includes a fuel source 103 configured to provide a fuel input stream 104. In some embodiments, the fuel input stream 104 includes or consists of synthesis gas (e.g., syngas).

The fuel input system 102 also includes a first fuel input treatment unit 106 that treats the fuel input stream 104. In some embodiments, the first fuel input treatment unit 106 includes a shift reactor that converts carbon monoxide and water in the fuel input stream 104 into carbon dioxide and hydrogen. In other embodiments, the first fuel input treatment unit 106 includes a carbonyl sulfide (e.g., COS) hydrolysis system that converts carbonyl sulfide in the fuel input stream 104 to hydrogen sulfide. In yet other embodiments, the first fuel input treatment unit 106 includes both the shift reactor and the COS hydrolysis system. The fuel input system 102 may include a bypass conduit 108 configured to allow the fuel input stream 104 to bypass (e.g., pass around, etc.) the first fuel input treatment unit 106, when the treatments within the first fuel input treatment unit 106 are unnecessary or undesirable.

The fuel input system 102 may also include a second fuel input treatment unit 110. The second fuel input treatment unit 110 is downstream of the first fuel input treatment unit 106 and is configured to treat the fuel input stream 104. In some embodiments, the second fuel input treatment unit 110 includes a mercury (e.g., Hg) removal system that removes mercury from the fuel input stream 104.

The fuel input system 102 may also include a third fuel input treatment unit 112. The third fuel input treatment unit 112 is downstream of the second fuel input treatment unit 110 and is configured to treat the fuel input stream 104. In some embodiments, the third fuel input treatment unit 112 includes a carbon dioxide absorption system configured for use with an acid gas removal solvent, such as Selexol™. Selexol™ is a polyethylene glycol dimethyl ether (PGDE) based solvent, which is a physical solvent that, unlike amine-based acid gas removal solvents, does not chemically react with the acid gases contained in a stream (e.g., the fuel input stream 104) in order to separate acid gases. In these embodiments, the third fuel input treatment unit 112 includes a carbon dioxide output stream 114 configured to output the carbon dioxide extracted from the fuel input stream 104 via the carbon dioxide absorption system.

The fuel input system 102 may include a first cooler 116. The first cooler 116 may be located downstream of the third fuel input treatment unit 112 and configured to cool (e.g., chill, decrease temperature of, etc.) the fuel input stream 104. The fuel input system 102 may also include a fuel expansion system 118 that expands the fuel input stream 104. The fuel expansion system 118 includes an expansion turbine 120 and a motor/generator 122. The expansion turbine 120 may be located downstream of the first cooler 116 and configured to expand the fuel input stream 104, thereby generating kinetic energy for the motor/generator 122.

The fuel cell system 100 includes a first combining junction 123 configured to receive the fuel input stream 104 from the expansion turbine 120 and output a mixed stream. The fuel cell system 100 also includes a first heat recovery steam generator 142 (e.g., heat exchanger, etc.) that receives the mixed stream from the first combining junction 123 and outputs the mixed stream.

The fuel cell system 100 also includes a natural gas input system 132 configured to input natural gas into the fuel cell system 100. The natural gas input system 132 includes a natural gas source 133 configured to provide a natural gas input stream 134.

The natural gas input system 132 may include a fourth fuel input treatment unit 136 that treats the natural gas input stream 134. In some embodiments, the fourth fuel input treatment unit 136 includes an activated carbon polisher that removes contaminations, such as anode poisoning sulfur compounds, from the natural gas input stream 134. The natural gas input system 132 may also include a fifth fuel input treatment unit 138 located downstream of the fourth fuel input treatment unit 136 and configured to further treat the natural gas input stream 134. In some embodiments, the fifth fuel input treatment unit 138 includes a pre-reformer that converts at least a portion of the natural gas input stream 134 into hydrogen.

The fuel cell system 100 also includes a fuel cell 124 (e.g., fuel cell stack, etc.) configured to generate electrical energy. In some embodiments, the fuel cell 124 is a solid oxide fuel cell (e.g., SOFC). The fuel cell 124 includes an anode section 126 having an anode inlet configured to receive an anode input stream 128 and an anode outlet configured to output an anode exhaust stream 130. The anode input stream 128 includes (i) the mixed stream from the first heat recovery steam generator 142, and (ii) the natural gas input stream 134 from the fifth fuel input treatment unit 138. The anode exhaust stream 130 is received by the first heat recovery steam generator 142, where heat from the anode exhaust stream 130 is used to heat the mixed stream received from the first combining junction 123.

The fuel cell system 100 may include an anode exhaust gas recycle system 140 that recycles unburned fuel from the anode exhaust stream 130. The anode exhaust gas recycle system 140 may include a first heater 144. The first heater 144 may be located downstream of the first heat recovery steam generator 142 and configured to heat the anode exhaust stream 130. The anode exhaust gas recycle system 140 may also include a condensate tank 146. The condensate tank 146 may be located downstream of the first heater 144 and configured to store condensate formed in the anode exhaust stream 130. The condensate tank 146 may include a water output stream 148 configured to output water stored within the condensate tank 146.

The fuel cell system 100 may include a first separating junction 149 configured to receive the anode exhaust stream 130 from the condensate tank 146 and output multiple portions of the anode exhaust stream 130. For example, the first separating junction 149 may be configured to output the anode exhaust stream 130 in three portions (e.g., (i) a first portion of the anode exhaust stream 130, (ii) a second portion of the anode exhaust stream 130, and (iii) a third portion of the anode exhaust stream 130).

The anode exhaust gas recycle system 140 includes a first blower 150. The first blower 150 (i) receives the first portion of the anode exhaust stream 130 from the first separating junction 149, (ii) pressurizes the first portion of the anode exhaust stream 130, and (iii) outputs the first portion of the anode exhaust stream 130 to the first combining junction 123. The first combining junction 123 (i) receives the first portion of the anode exhaust stream 130 from the first blower 150, (ii) combines the first portion of the anode exhaust stream 130 with the fuel input stream 104 received from the expansion turbine 120, and (iii) outputs a mixture of the first portion of the anode exhaust stream 130 and the fuel input stream 104 as the mixed stream.

The anode exhaust gas recycle system 140 may also include a compressor 152. The compressor 152 (i) receives the second portion of the anode exhaust stream 130 from the first separating junction 149, (ii) pressurizes the second portion of the anode exhaust stream 130, and (iii) outputs the second portion of the anode exhaust stream 130 to a conduit extending between the second fuel input treatment unit 110 and the third fuel input treatment unit 112 (e.g., downstream of the second fuel input treatment unit 110 and upstream of the third fuel input treatment unit 112). In some embodiments, the compressor 152 is a blower.

The fuel cell system 100 may include an air input system 154 configured to input air into the fuel cell system 100. The air input system 154 includes an air source 155 configured to provide an air input stream 156. The air input system 154 may also include a second blower 158. The second blower 158 (i) receives the air input stream 156 from the air source 155, (ii) pressurizes the air input stream 156, and (iii) outputs the air input stream 156. The air input system 154 may also include a second cooler 160. The second cooler 160 may be located downstream of the second blower 158 and configured to cool the air input stream 156.

The fuel cell 124 also includes a cathode section 162 having a cathode inlet configured to receive a cathode input stream 164 and a cathode outlet configured to output a cathode exhaust stream 166. The fuel cell system 100 may include a second separating junction 167 configured to receive the cathode exhaust stream 166 from the cathode outlet and output multiple portions of the cathode exhaust stream 166. For example, the second separating junction 167 may be configured to output the cathode exhaust stream 166 in two portions (e.g., (i) a first portion of the cathode exhaust stream 166 and (ii) a second portion of the cathode exhaust stream 166). The fuel cell 124 also includes an electrolyte layer 196 coupled between the anode section 126 and the cathode section 162 and configured to allow exchange of hydrogen ions between the anode section 126 and the cathode section 162.

The fuel cell system 100 may include an air recycle system 168 configured to recycle unutilized air from the cathode exhaust stream 166. The air recycle system 168 may include a third blower 170. The third blower 170 (i) receives the first portion of the cathode exhaust stream 166 from the cathode outlet, (ii) pressurizes the first portion of the cathode exhaust stream 166, and (iii) outputs the first portion of the cathode exhaust stream 166 upstream of the cathode inlet. The cathode input stream 164 includes the first portion of the cathode exhaust stream 166 from the third blower 170 and the air input stream 156 from the second cooler 160.

The fuel cell system 100 may include a second combining junction 173 configured to receive and combine the third portion of the anode exhaust stream 130 received from the first separating junction 149 and the second portion of the cathode exhaust stream 166 received from the second separating junction 167, and output a waste air and fuel stream 174. The air recycle system 168 may include an anode gas oxidizer (e.g., AGO) 176 configured to receive the waste air and fuel stream 174, burn any unburned fuel within the waste air and fuel stream 174, and output a burnt waste air and fuel stream 177.

The fuel cell system 100 may include a water system 178 configured to extract energy from the burnt waste air and fuel stream 177. The water system 178 may include a water source 179 configured to provide a water input stream 180. The water system 178 may also include a third combining junction 181 configured to receive the water input stream 180 and output a water stream.

The water system 178 may include a fourth blower 182. The fourth blower 182 receives the water stream from the third combining junction 181, pressurizes the water stream, and outputs the water stream. The water system 178 may also include a second heat recovery steam generator 184 downstream of the fourth blower 182. The second heat recovery steam generator 184 (i) receives the burnt waste air and fuel stream 177 from the AGO 176 and outputs the burnt waste air and fuel stream 177, and (ii) receives the water stream from the fourth blower 182 and outputs the water stream. The second heat recovery steam generator 184 is configured to heat the water stream using heat from the burnt waste air and fuel stream 177.

The water system 178 may also include an energy generation system 186 configured to extract energy from the water stream. The energy generation system 186 includes a steam turbine 188 and a generator 190. The steam turbine 188 may be located downstream of the second heat recovery steam generator 184 and configured to receive the water stream from the second heat recovery steam generator 184. The steam turbine 188 converts potential energy of the water stream into kinetic energy, and the generator 190 transforms the kinetic energy from the steam turbine 188 into electrical energy. The steam turbine 188 includes a steam output stream 192 configured to direct excess steam from the steam turbine 188 to a conduit extending between the fourth fuel input treatment unit 136 and the fifth fuel input treatment unit 138 (e.g., downstream of the fourth fuel input treatment unit 136 and upstream of the fifth fuel input treatment unit 138). The steam turbine 188 outputs a recycle water stream.

The water system 178 may include a second heater 194. The second heater 194 may be located downstream of the steam turbine 188 and configured to (i) receive the recycle water stream from the steam turbine 188, (ii) heat the recycle water stream, and (iii) output the recycle water stream to the third combining junction 181. The third combining junction 181 is configured to (i) receive the recycle water stream from the second heater 194, (ii) combine the recycle water stream with the water input stream 180 from the water source 179, and (iii) output a mixture of the recycle water stream and the water input stream 180 as the water stream.

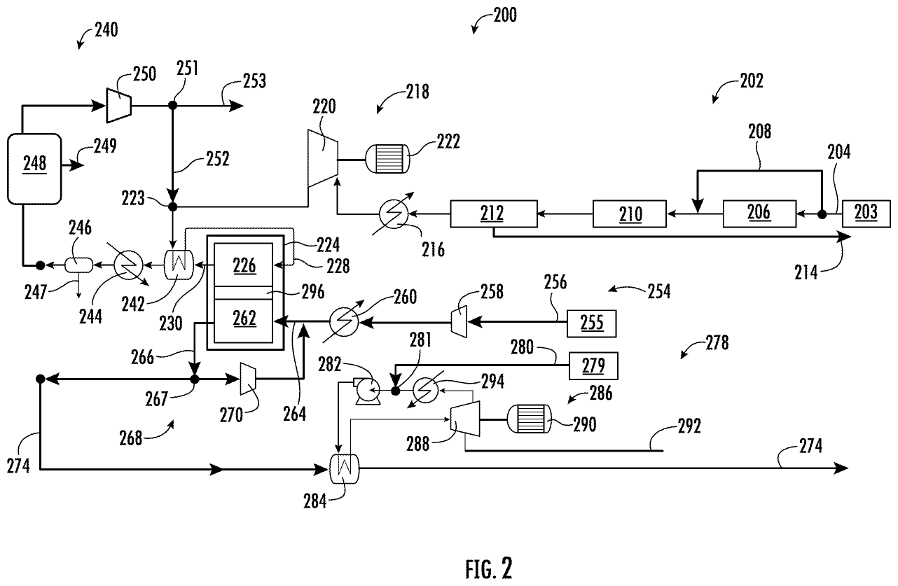

Referring to FIG. 2, a fuel cell system 200 according to an example embodiment is shown. The fuel cell system 200 includes a fuel input system 202 configured to input fuel into the fuel cell system 200. The fuel input system 202 includes a fuel source 203 configured to provide a fuel input stream 204. In some embodiments, the fuel input stream 204 includes or consists of syngas.

The fuel input system 202 may include a first fuel input treatment unit 206 that treats the fuel input stream 204. The first fuel input treatment unit 206 may include similar systems and/or treatments as the first fuel input treatment unit 106. The fuel input system 202 may include a second bypass conduit 208 configured to allow the fuel input stream 204 to bypass the first fuel input treatment unit 206, when the treatments within the first fuel input treatment unit 206 are unnecessary or undesirable.

The fuel input system 202 may also include a second fuel input treatment unit 210. The second fuel input treatment unit 210 may be located downstream of the first fuel input treatment unit 206 and configured to treat the fuel input stream 204. The second fuel input treatment unit 210 may include similar systems and/or treatments as the second fuel input treatment unit 110

The fuel input system 202 may also include a third fuel input treatment unit 212. The third fuel input treatment unit 212 may be located downstream of the second fuel input treatment unit 210 and configured to treat the fuel input stream 204. In some embodiments, the third fuel input treatment unit 212 is a first carbon dioxide removal system configured to remove carbon dioxide from the fuel input stream 204 and includes a carbon dioxide absorption system configured for use with an acid gas removal solvent, such as Selexol™. In these embodiments, the third fuel input treatment unit 212 includes a carbon dioxide output stream 214 configured to output carbon dioxide extracted from the fuel input stream 204 via the carbon dioxide absorption system.

The fuel input system 202 may include a first cooler 216. The first cooler 216 may be located downstream of the third fuel input treatment unit 212 and configured to cool the fuel input stream 204. The fuel input system 202 may also include a fuel expansion system 218 that expands the fuel input stream 204. The fuel expansion system 218 may include an expansion turbine 220 and an engine 222. The expansion turbine 220 may be located downstream of the first cooler 216 and configured to expand the fuel input stream 204 via kinetic energy generated by the engine 222.

The fuel cell system 200 may include a first combining junction 223 configured to receive the fuel input stream 204 from the expansion turbine 220 and output a mixed stream. The fuel cell system 200 may also include a first heat recovery steam generator 242 that receives the mixed stream from the first combining junction 223 and outputs the mixed stream.

The fuel cell system 200 also includes a fuel cell 224 configured to generate electrical energy. In some embodiments, the fuel cell 224 is a SOFC. The fuel cell 224 includes an anode section 226 having an anode inlet configured to receive an anode input stream 228 and an anode outlet configured to output an anode exhaust stream 230. The anode input stream 228 includes the mixed stream from the first heat recovery steam generator 242. The anode exhaust stream 230 is configured to be received by the first heat recovery steam generator 242, where heat from the anode exhaust stream 230 is used to heat the mixed stream from the first combining junction 223.

The fuel cell system 200 may include an anode exhaust gas recycle system 240 that recycles unburned fuel from the anode exhaust stream 230. The anode exhaust gas recycle system 240 may include a first heater 244. The first heater 244 may be located downstream of the first heat recovery steam generator 242 and configured to heat the anode exhaust stream 230. The anode exhaust gas recycle system 240 may also include a condensate tank 246. The condensate tank 246 may be located downstream of the first heater 244 and configured to store condensate formed in the anode exhaust stream 230. The condensate tank 246 includes a water output stream 247 configured to output water stored within the condensate tank 246.

The anode exhaust gas recycle system 240 may also include a fuel recycle treatment unit 248. The fuel recycle treatment unit 248 may be located downstream of the condensate tank 246 and configured to receive and treat the anode exhaust stream 230 from the condensate tank 246. In some embodiments, the fuel recycle treatment unit 248 is a second carbon dioxide removal system having an amine-type carbon dioxide adsorption system. In this embodiment, the fuel recycle treatment unit 248 includes a carbon dioxide outlet stream 249 configured to output carbon dioxide removed from the anode exhaust stream 230 via the second carbon dioxide removal system.

The anode exhaust gas recycle system 240 may also include a first blower 250. The first blower 250 (i) receives the anode exhaust stream 230 from the fuel recycle treatment unit 248, (ii) pressurizes the anode exhaust stream 230, and (iii) outputs the anode exhaust stream 230. The fuel cell system 200 may include a first separating junction 251 configured to receive the anode exhaust stream 230 from the first blower 250 and output multiple portions of the anode exhaust stream 230. For example, the first separating junction 251 may output the anode exhaust stream 230 in two portions (e.g., (i) a first portion 252 of the anode exhaust stream 230 and (ii) a second portion 253 of the anode exhaust stream 230). In some embodiments (not shown), the anode exhaust gas recycle system 240 includes a shift reactor configured to convert carbon monoxide and water in the anode exhaust stream 230 into carbon dioxide and hydrogen.

In some embodiments, the first combining junction 223 (i) receives the first portion 252 of the anode exhaust stream 230 from the first separating junction 251, (ii) combines the first portion 252 of the anode exhaust stream 230 with the fuel input stream 204 from the expansion turbine 220, and (iii) outputs a mixture of the first portion 252 of the anode exhaust stream 230 and the fuel input stream 204 as the mixed stream. In some embodiments, the second portion 253 of the anode exhaust stream 230 is directed to a waste fuel heat recovery system.

The fuel cell system 200 may include an air input system 254 configured to input air into the fuel cell system 200. The air input system 254 includes an air source 255 configured to provide an air input stream 256. The air input system 254 may also include a second blower 258. The second blower 258 (i) receives the air input stream 256 from the air source 255, (ii) pressurizes the air input stream 256, and (iii) outputs the air input stream 256. The air input system 254 may also include a second cooler 260. The second cooler 260 may be located downstream of the second blower 258 and configured to cool the air input stream 256.

The fuel cell 224 also includes a cathode section 262 having a cathode inlet configured to receive a cathode input stream 264 and a cathode outlet configured to output a cathode exhaust stream 266. The fuel cell system 200 may include a second separating junction 267 configured to receive the cathode exhaust stream 266 from the cathode outlet and output multiple portions of the cathode exhaust stream 266. For example, the second separating junction 267 may output two portions of the cathode exhaust stream 266 (e.g., (i) a first portion of the cathode exhaust stream 266 and (ii) a second portion of the cathode exhaust stream 266, e.g., a waste air stream 274). The fuel cell 224 also includes an electrolyte layer 296 coupled between the anode section 226 and the cathode section 262 and configured to allow exchange of oxygen ions between the cathode section 262 and the anode section 226.

The fuel cell system 200 may include an air recycle system 268 configured to recycle unutilized air from the cathode exhaust stream 266. The air recycle system 268 may include a third blower 270. The third blower 270 (i) receives the first portion of the cathode exhaust stream 266 from the second separating junction 267, (ii) pressurizes the first portion of the cathode exhaust stream 266, and (iii) outputs the first portion of the cathode exhaust stream 266 upstream of the cathode inlet. The cathode input stream 264 includes the first portion of the cathode exhaust stream 266 from the third blower 270 and the air input stream 256 from the second cooler 260. In some embodiments, the air recycle system 268 does not integrate with an AGO. In other embodiments, the air recycle system 268 does include an AGO that is minimally used.

The fuel cell system 200 may include a water system 278 configured to extract energy from the waste air stream 274. The water system 278 includes a water source 279 configured to provide a water input stream 280. The water system 278 may also include a second combining junction 281. The second combining junction 281 is configured to receive the water input stream 280 and output a water stream.

The water system 278 may include a fourth blower 282. The fourth blower 282 (i) receives the water stream from the second combining junction 281, (ii) pressurizes the water stream, and (ii) outputs the water stream. The water system 278 may also include a second heat recovery steam generator 284 downstream of the fourth blower 282. The second heat recovery steam generator 284 (i) receives the waste air stream 274 from the second separating junction 267 and outputs the waste air stream 274 and (ii) receives the water stream from the fourth blower 282 and outputs the water stream. The second heat recovery steam generator 284 is configured to heat the water stream using heat from the waste air stream 274.

The water system 278 also includes an energy generation system 286 configured to extract energy from the water stream. The energy generation system 286 may include a steam turbine 288 and a generator 290. The steam turbine 288 may be located downstream of the second heat recovery steam generator 284 and configured to receive the water stream from the second heat recovery steam generator 284. The steam turbine 288 converts the potential energy of the water stream into kinetic energy, and the generator 290 transforms the kinetic energy from the steam turbine 288 into electrical energy. The steam turbine 288 may include a steam output stream 292 configured to output excess steam from the steam turbine 288. The steam turbine 288 outputs a recycle water stream.

The water system 278 may include a second heater 294. The second heater 294 may be located downstream of the steam turbine 288 and configured to (i) receive the recycle water stream from the steam turbine 288, (ii) heat the recycle water stream, and (iii) output the recycle water stream to the second combining junction 281. The second combining junction 281 is configured to (i) receive the recycle water stream from the second heater 294, (ii) combine the recycle water stream with the water input stream 280 from the water source 279, and (iii) output a mixture of the recycle water stream and the water input stream 280 as the water stream.

While the fuel cell system 100 described above converts a fair amount of fuel from the fuel source 103 to usable electrical energy via the fuel cell 124, the fuel cell system 200 described above is capable of converting nearly the entirety (e.g., approximately 100%) of fuel from the fuel source 203 to usable electrical energy via the fuel cell 224. The fuel cell system 200 is capable of this high conversion of fuel to electrical energy by increasing the system fuel utilization within the anode exhaust gas recycle system 240.

Compared to the anode exhaust gas recycle system 140, the anode exhaust gas recycle system 240 only recycles fuel (e.g., anode exhaust stream 230) to the first combining junction 223, which allows for the anode exhaust gas recycle system 240 to operate under low pressure. Additionally, the anode exhaust gas recycle system 240 includes the second carbon dioxide removal system within the fuel recycle treatment unit 248, removing the need of recycling fuel to the fuel input system 202 in order to pass through the first carbon dioxide removal system of the second fuel input treatment unit 210. The anode exhaust gas recycle system 140, however, recycles a portion of the fuel (e.g., anode exhaust stream 130) to the fuel input system 102 in order pass through the carbon dioxide absorption system of the second fuel input treatment unit 110, which causes the anode exhaust gas recycle system 140 to operate under high pressure. This operation of the anode exhaust gas recycle system 140 under high pressure results in high power usage, reducing efficiency of the fuel cell system 100. Moreover, the fuel cell system 100 burns a portion of fuel via the AGO 176 instead of recycling the entirety of fuel.

Peak efficiency of the fuel cell system 200 occurs when the fuel cell 224 utilizes the following elements and compounds within the noted proportions: hydrogen, e.g., H₂ (29.2%-40.9%), methane, e.g., CH₄ (0.7%-0.9%), carbon monoxide, e.g., CO (0.7%-1.3%), water, e.g., H₂O (6.1%-6.4%), argon, e.g., Ar (8.2%-10.2%), nitrogen, e.g., Na (41.8%-52%), and carbon dioxide, e.g., CO₂ (0.7%-0.8%). It is important to note that the list of elements and compounds above are not limiting and may include other elements and/or compounds or may exclude elements and/or compounds. Additionally, it is important to note that the listed proportions of the list of elements and compounds above are not limiting and can include various proportions that are not included.

It is important to note that any element disclosed in one embodiment may be incorporated or utilized with any other embodiment disclosed herein. For example, the fuel cell system 100 of the exemplary embodiment described in FIG. 1, or components (e.g., systems, units, parts, etc.) of the fuel cell system 100, may be incorporated into the fuel cell system 200 of the exemplary embodiment described in FIG. 2, or components of the fuel cell system 200. Although only some examples of elements from one embodiment that can be incorporated or utilized in another embodiment have been described above, it should be appreciated that other elements of the various embodiments may be incorporated or utilized with any of the other embodiments disclosed herein.

In some embodiments, a method of generating electrical energy using the fuel cell system 200 includes providing the fuel cell system 200. The fuel cell system 200 includes a fuel source 203, a first carbon dioxide removal system (e.g., the third fuel input treatment unit 212), and a fuel cell stack 224. The fuel cell stack 224 includes an anode section 226 having an anode inlet, and an anode outlet, and a cathode section 262 having a cathode inlet, and a cathode outlet. The fuel cell system 200 further includes an anode exhaust gas recycle system 240 having a second carbon dioxide removal system (e.g., the fuel recycle treatment unit 248), and a combining junction (e.g., the first combining junction 223).

The method may include, at the first carbon dioxide removal system, receiving a fuel input stream 204 from the fuel source 203, and removing carbon dioxide from the fuel input stream 204, and, at the anode section 226 of the fuel cell stack 224, receiving an anode input stream 228 into the anode inlet, and outputting an anode exhaust stream 230 from the anode outlet.

The method may include, at the cathode section 262 of the fuel cell stack 224, receiving a cathode input stream 264 into the cathode inlet, and outputting a cathode exhaust stream 266 from the cathode outlet, and, at the second carbon dioxide removal system, receiving the anode exhaust stream 230 and removing carbon dioxide from the anode exhaust stream 230.

The method may include, at the combining junction, receiving (i) the fuel input stream 204 from the first carbon dioxide removal system, and (ii) the anode exhaust stream 230 from the second carbon dioxide removal system, and outputting a mixed stream to the anode inlet as the anode input stream 228.

### III. Configuration of Example Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A fuel cell system comprising:
a fuel source configured to provide a fuel input stream;
a first carbon dioxide removal system configured to receive the fuel input stream and remove carbon dioxide from the fuel input stream;
a fuel cell stack comprising:
an anode section comprising an anode inlet configured to receive an anode input stream, and an anode outlet configured to output an anode exhaust stream, and
a cathode section comprising a cathode inlet configured to receive a cathode input stream, and a cathode outlet configured to output a cathode exhaust stream;
an anode exhaust gas recycle system comprising a second carbon dioxide removal system configured to receive the anode exhaust stream and remove carbon dioxide from the anode exhaust stream; and
a combining junction configured to receive (i) the fuel input stream from the first carbon dioxide removal system, and (ii) the anode exhaust stream from the second carbon dioxide removal system, and to output a mixed stream to the anode inlet as the anode input stream.

2. The system of claim 1, wherein the fuel cell stack is a solid oxide fuel cell stack.

3. The system of claim 1, wherein the fuel input stream comprises syngas.

4. The system of claim 1, wherein the first carbon dioxide removal system is a carbon dioxide absorption system configured for use with an acid gas removal solvent.

5. The system of claim 1, wherein the second carbon dioxide removal system is an amine-type carbon dioxide adsorption system.

6. The system of claim 1, wherein the first carbon dioxide removal system is a carbon dioxide absorption system configured for use with an acid gas removal solvent, and the second carbon dioxide removal system is an amine-type carbon dioxide adsorption system.

7. The system of claim 1, wherein the anode exhaust gas recycle system further comprises a shift reactor configured to receive the anode exhaust stream and to convert carbon monoxide and water in the anode exhaust stream into carbon dioxide and hydrogen.

8. The system of claim 1, further comprising a heat recovery steam generator configured to receive the cathode exhaust stream and to heat a water stream using heat from the cathode exhaust stream.

9. The system of claim 8, further comprising an energy generation system, the energy generation system comprising a steam turbine and a generator, wherein the steam turbine is configured to receive the water stream from the heat recovery steam generator.

10. The system of claim 8, wherein the heat recovery steam generator is configured to receive the cathode exhaust stream directly from the cathode outlet.

11. The system of claim 1, wherein the system does not comprise an anode gas oxidizer.

12. The system of claim 1, further comprising a separating junction configured to receive the anode exhaust stream from the second carbon dioxide removal system, and to output (i) a first portion of the anode exhaust stream to the combining junction, and (ii) a second portion of the anode exhaust stream to a waste fuel heat recovery system.

13. A method of generating electrical energy using a fuel cell system, the method comprising:
providing the fuel cell system, which comprises:
a fuel source,
a first carbon dioxide removal system,
a fuel cell stack comprising:
an anode section comprising an anode inlet, and an anode outlet, and
a cathode section comprising a cathode inlet, and a cathode outlet;
an anode exhaust gas recycle system comprising a second carbon dioxide removal system, and
a combining junction;
at the first carbon dioxide removal system, receiving a fuel input stream from the fuel source, and removing carbon dioxide from the fuel input stream;
at the anode section of the fuel cell stack, receiving an anode input stream into the anode inlet, and outputting an anode exhaust stream from the anode outlet;
at the cathode section of the fuel cell stack, receiving a cathode input stream into the cathode inlet, and outputting a cathode exhaust stream from the cathode outlet;
at the second carbon dioxide removal system, receiving the anode exhaust stream and removing carbon dioxide from the anode exhaust stream; and
at the combining junction, receiving (i) the fuel input stream from the first carbon dioxide removal system, and (ii) the anode exhaust stream from the second carbon dioxide removal system, and outputting a mixed stream to the anode inlet as the anode input stream.

14. The method of claim 13, wherein, at the first carbon dioxide removal system, the step of removing the carbon dioxide from the fuel input stream is performed using an acid gas removal solvent.

15. The method of claim 13, wherein, at the second carbon dioxide removal system, the step of removing the carbon dioxide from the anode exhaust stream is performed using an amine-type carbon dioxide adsorption system.

16. The method of claim 13, wherein:
at the first carbon dioxide removal system, the step of removing the carbon dioxide from the fuel input stream is performed using an acid gas removal solvent; and
at the second carbon dioxide removal system, the step of removing the carbon dioxide from the anode exhaust stream is performed using an amine-type carbon dioxide adsorption system.

17. The method of claim 13, wherein:
the fuel cell system further comprises a shift reactor; and
the method further comprises, at the shift reactor, converting carbon monoxide and water in the anode exhaust stream into carbon dioxide and hydrogen.

18. The method of claim 13, wherein:
the fuel cell system further comprises a heat recovery steam generator; and
the method further comprises, at the heat recovery steam generator, heating a water stream using heat from the cathode exhaust stream.

19. The method of claim 18, wherein:
the fuel cell system does not comprise an anode gas oxidizer; and
the method further comprises, at the heat recovery steam generator, receiving the cathode exhaust stream directly from the cathode outlet.

20. The method of claim 18, wherein:
the fuel cell system further comprises an energy generation system comprising a steam turbine and a generator; and
the method further comprises, at the heat recovery steam generator, directing the water stream to the steam turbine.

21. The method of claim 13, wherein:
the fuel cell system further comprises a separating junction; and
the method further comprises, at the separating junction, receiving the anode exhaust stream, and outputting (i) a first portion of the anode exhaust stream to the combining junction, and (ii) a second portion of the anode exhaust stream to a waste fuel heat recovery system.
